(19) United States
(12) Patent Application Publication
(10) Pub. No.: US 2024/0262714 A1
(43) Pub. Date: Aug. 8, 2024

(54) Water Filter and Purifier

(71) Applicant: Epic Life Inc., Boulder, CO (US)

(72) Inventors: Ryan David Weitz, Palm Harbor, FL (US); Peter Cicchetto, Northport, FL (US)

(21) Appl. No.: 18/163,939

(22) Filed: Feb. 3, 2023

(51) Int. Cl. C02F 1/00; B01D 39/20; C02F 1/28; C02F 1/48

(52) U.S. Cl. CPC C02F 1/003; B01D 39/2065; B01D 39/2082; C02F 1/281; C02F 1/283; C02F 1/288; C02F 1/48; C02F 2201/003; C02F 2201/004; C02F 2201/006; C02F 2307/02; C02F 2307/04

(57) ABSTRACT

A user-replaceable filter unit may include a combination of an activated carbon fiber filter and an electrically charged fiber filter. The replaceable filter unit may be secured in a housing and positioned within a larger filtering system, for example a bottle, container, pitcher, etc.

### BACKGROUND

### Field of the Disclosure

Aspects of this disclosure relate to water filtration and purification systems. The systems may be hand-held, portable or non-portable. Various aspects include suction, pressure and gravity driven filtration systems with replaceable filter elements.

### Description of Related Art

Many different water filters remove soluble contaminants as well as particulate matter. These filters, while fairly effective in the applications for which they were designed, have various trade-offs. Such filters may need to meet certain environmental standards, while having sediment holding capacity, not suffering from pressure drop, be affordable and durable. They include: point of entry, for example, serving a residence or commercial structure; point of use, for example, at an outlet; in a pitcher; and in a portable container such as a bottle. Pitchers and portable devices may need a low pressure drop across the filter because of the greatly reduced available pressure from mouth suction or gravity. As the filtering requirements increase, thicker filters become necessary, with a corresponding drop in pressure.

The need for safe drinking water is ever present, but the availability of safe drinking water, even in developed countries, is increasingly being called into question. Aging infrastructure, neglected water treatment plants, corrupt government officials and other factors increase the need for personal and household water treatment.

With respect to developing nations (or rural parts of developed ones), there is little focus on improvement of municipal water systems. For years locals have relied on a river to provide them with drinking water. Now, though, those locals are dying of cancer. Many small villages have joined the ranks of what China's media calls the country's “cancer villages.”

The situation is worse in African communities, where most of the time there is no power or local sources of water, and drinking water is brought from contaminated surface sources. There is a high death rate from gastro-intestinal diseases throughout these areas, and many infants die from waterborne diseases.

Fibrous media may remove microbial pathogens. Activated carbon can remove bad tastes and odor from water, as well as chlorine and other chemicals such as halogenated hydrocarbons and cancer-causing pesticides. Ion exchange resins can remove metal and other ions. However, no single material or chemical exists that is able to remove all contaminants.

Granular activated carbon (GAC), which is useful for removing many soluble contaminants, is difficult to commercialize, particularly in portable devices, which are subject to vibration and motion. Carbon blocks are easily fouled by small particles, and a prefilter is typically needed.

Particulate and chemical contaminants may be removed by non-woven fibrous media. Such a structure minimizes channeling and allows filter design variation. Non-woven media are inexpensive to manufacture as paper filters and are used extensively in residential and commercial water purification devices.

Iodine has been used to sterilize drinking water. Effective purification requires large quantities of iodine (at least 1 mg/l) and requires time. Removal of the iodine is preferred by most people because at iodine concentrations of 4 mg/l, water acquires an unpleasant odor.

A desirable filter removes taste and odor-causing molecules, cysts such as Cryptosporidium, bacteria, virus, turbidity (that might be toxic and might also harbor pathogens), chlorine, organic matter, inorganic matter and heavy metals. The filter should be effective for portable and low-draw applications such as gravity filtration (pitchers), and affordable.

### SUMMARY

The systems, methods and devices of this disclosure each have several innovative aspects, no single one of which is solely responsible for the desirable attributes disclosed herein.

A water filter may include an activated carbon fiber (ACF) filter having an inner wall and an outer wall, with a thickness defined by the distance between the inner and outer walls, the ACF filter further including a hollow interior defined by the inner wall. An electrically charged fiber (ECF) filter may comprise a support layer coupled to an active layer, the active layer comprising a plurality of electrically charged fibers, the ECF filter coupled to the ACF filter. A top end-cap may be coupled to at least one of the ACF filter and the ECF filter, the top end-cap may be configured to provide access from outside of the water filter to the hollow interior.

The ECF filter may surround the ACF filter. The ECF filter and the ACF filter may each have a cylindrical shape and further include a bottom end-cap coupled to both the ACF filter and the ECF filter.

The ECF filter may have a plurality of pleats, the active layer may further comprise an alumina fiber layer with a positive electrical charge. The alumina fiber layer may further comprise aluminum oxide fibers having a diameter from 1 to 10 nanometers with a longitudinal/cross section ratio in excess of 5.

The alumina fiber layer may further comprise a combination of aluminum hydroxide (Al(OH)3) and boehmite (AlOOH). The active layer may be coupled to the support layer.

The support layer may further comprise a synthetic polymer. The active layer may further comprise a borosilicate fiber glass filter media. The ECF filter may further comprise a blend of alumina fibers and microglass having from 70% to 80% void volume. The ECF filter may further comprise a non-woven matrix of microglass fibers, cellulose and alumina fibers. The support layer may further comprise a plurality of support layers, the active layer between at least two of the plurality of support layers. The bottom end-cap may further comprise a base, a wall extending away from the base and encircling the base, a ring extending away from the base and centrally positioned, and a plurality of concentric ridges extending away from the base and located between the wall and the ring, the concentric ridges having a height lower than a height of either the wall or the ring. The bottom end-cap may further comprise a base, a wall extending away from the base and encircling the base, a ring extending away from the base and centrally positioned, and a plurality of concentric ridges extending away from the base and located between the wall and the ring, the concentric ridges having a height lower than a height of either the wall or the ring.

The pleats may have a height of less than 10 millimeters.

The top end-cap may further comprise a base, a wall extending away from and encircling the base of the top end-cap, a hollow ring extending away from the base of the top end-cap and centrally positioned, the hollow ring of the top end-cap having a space extending from one side of the circular base of the top end-cap and through the center to the opposite side of the circular based of the top end-cap, a plurality of concentric ridges extending away from the base of the top end-cap and located between the wall of the top end-cap and the ring of the top end-cap, the concentric ridges of the top end-cap having a height lower than a height of either the wall of the top end-cap or the ring of the top end-cap, and a fluid port attached to the base of the top end-cap on a side opposite the concentric ridges of the top end-cap, the fluid port extending away from the base of the top end-cap and providing fluid access between the hollow interior and outside the water filter.

The top end-cap and bottom end-cap may each be sealed to the ECF filter with an adhesive. The ACF filter thickness may be from 0.25″ to 0.75″. The water filter may further comprise a housing having an inlet, a lid removably coupled to the housing and removably coupled to the top end-cap, the combination of the housing and lid surrounding the ACF filter, the ECF filter, the top end-cap and the bottom end-cap, the inlet providing passage for liquid from outside the housing and through the ECF filter and ACF filter into the hollow interior.

The water filter may further comprise a reservoir with separate storage areas for filtered and unfiltered water, a housing removably coupled to the top end-cap, the housing further coupled to the reservoir, the housing configured to hold liquid and provide passage of liquid from the storage area for unfiltered water, into the hollow interior, from the hollow interior through the ACF filter and ECF filter, out of the housing and into the storage area for filtered water, and a gasket between the housing and the reservoir.

A filter may comprise a cylindrical case having a bottom, a wall coupled to the bottom and extending away from the bottom, and at least one knob extending from the wall and on the inside of the container, and an inlet, a lid fitting partially into the case, having a lip contacting an edge of the wall, the lid having at least one channel along the portion of lid fitting into the case, the channel sized larger than the knob and enabling the lid to rotatably engage with the case, and a replaceable element including an active carbon fiber layer coupled to an electropositive alumina fiber layer, the replaceable element removably coupled to the lid.

A pitcher filter may comprise a reservoir with separate storage areas for filtered and unfiltered water, and a replaceable element including an active carbon fiber layer coupled to an electropositive alumina fiber layer, the replaceable element removably coupled to the reservoir and configured to guide water from the storage area for unfiltered water, through the active carbon fiber layer and the electropositive alumina fiber layer, and into the storage area for filtered water, with the assistance of gravity.

The foregoing has outlined rather broadly the gestures and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of this disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a top perspective view illustrating one example of a water filter.

FIG. 2 is a top perspective view illustrating one example of an expanded water filter.

FIG. 3 is a top perspective view illustrating one example of an expanded water filter.

FIG. 4 is a top perspective view illustrating one example of an expanded water filter.

FIG. 5 is a partial cross-sectional view illustrating one example of an electrically charged fiber filter.

FIG. 6 is a magnified view illustrating one example of an active layer in an electrically charged fiber filter.

FIG. 7 is a top perspective view illustrating one example of a water filter.

FIG. 8 is a plan view illustrating one example of a water filter housing.

FIG. 9 is a plan view illustrating one example of the water filter housing from FIG. 8.

FIG. 10 is a cross-sectional view through line A-A of FIG. 9 illustrating one example of the water filter housing and water filter.

FIG. 11 is a perspective partial cutaway view of one example of a bottle containing a water filter.

FIG. 12 is a top perspective view illustrating one example of an expanded water filter.

FIG. 13 is a cross-sectional view through line B-B of FIG. 12 illustrating one example of the water filter housing and water filter.

FIG. 14 is a plan partial cutaway view of one example of a pitcher containing a water filter.

### DETAILED DESCRIPTION

Various aspects of the disclosure are described more fully herein with reference to the accompanying drawings. This disclosure may however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based at least in part on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented, or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure may be embodied by one or more elements of a claim.

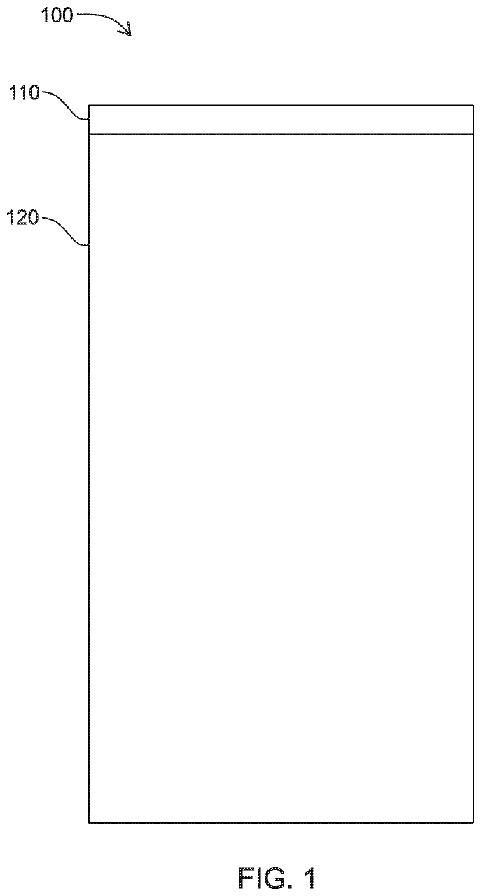

FIG. 1 is a top perspective view illustrating one example of water filter 100. Water filter 100 may be a replaceable element of a larger filtration system (not shown in FIG. 1) that may be capable of removing levels of: chlorine, particulates, volatile organic compounds (VOCs), inorganic compounds, bacteria, viruses, cysts and heavy metals, at specified inlet pressures and flow rates. In one aspect, water filter 100 may have a service interval of 3-4 months, after which a user could benefit from replacement of water filter 100. In one aspect, water filter 100 may have a longer service life. In one aspect, service life may be estimated in gallons filtered, instead of time. For example, a service interval may be 75 gallons, for example, or 50, 67, 93, 148, and so on, depending on filter design, material construction, water quality, etc.

Water filter 100 includes top end-cap 110 and filter element 120. Filter element 120 may represent a single or multiple types or styles of filter, and may be joined to top end-cap 110 through a variety of adhesives, or glue, for example a hot melt media, or may be a pressure fit, for example. In one aspect, the seam between filter element 120 and top end-cap 110 is waterproof. In another aspect, for example where top end-cap 110 is not expected to be submerged, the seam may not be waterproof. Water filter 100 operates (filters) liquid that passes through filter element 120. In one aspect, water may pass through filter element 120 by having water filter 100 at least partially submerged (or fully submerged) in water, and drawing water from around water filter 100 and into the interior of water filter 100, and up and out. Water may be drawn into water filter 100 and up through, for example, suction provided through a straw (not illustrated in FIG. 1).

In one aspect, water may pass through filter element 120 in the opposite direction. Water filter 100 may be part of a pitcher filter (not illustrated in FIG. 1), for example. Water could be above water filter 100 in a storage container, with gravity creating the pressure to force water into the interior of the water filter 100, and from the interior to the outside of the water filter 100. Filtration can effectively reach contaminant reduction goals by filtering water in either direction. There may be differences in water filter function depending on the direction of water flow. For example, water filter 100 may have different filtration rates, or different contaminant reduction levels, or a different life span depending on direction.

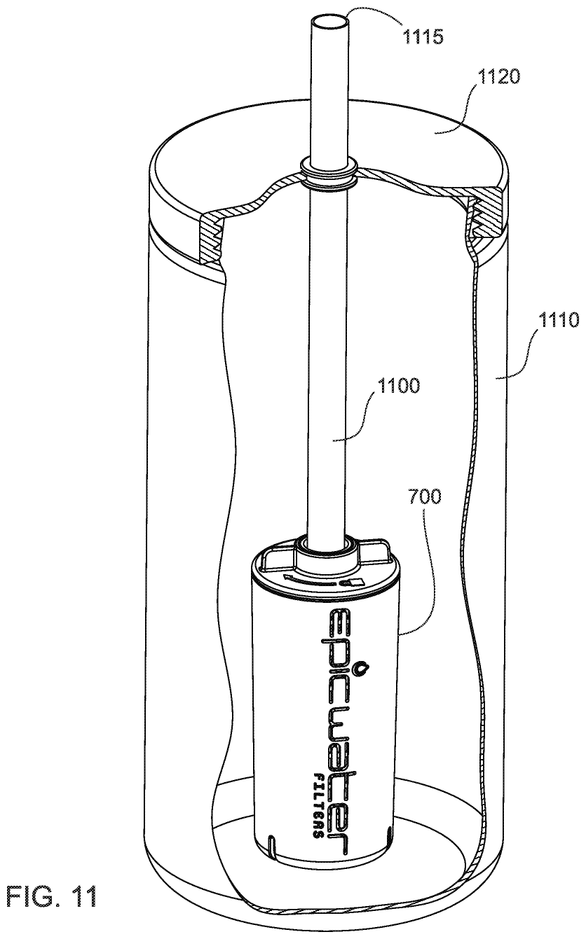

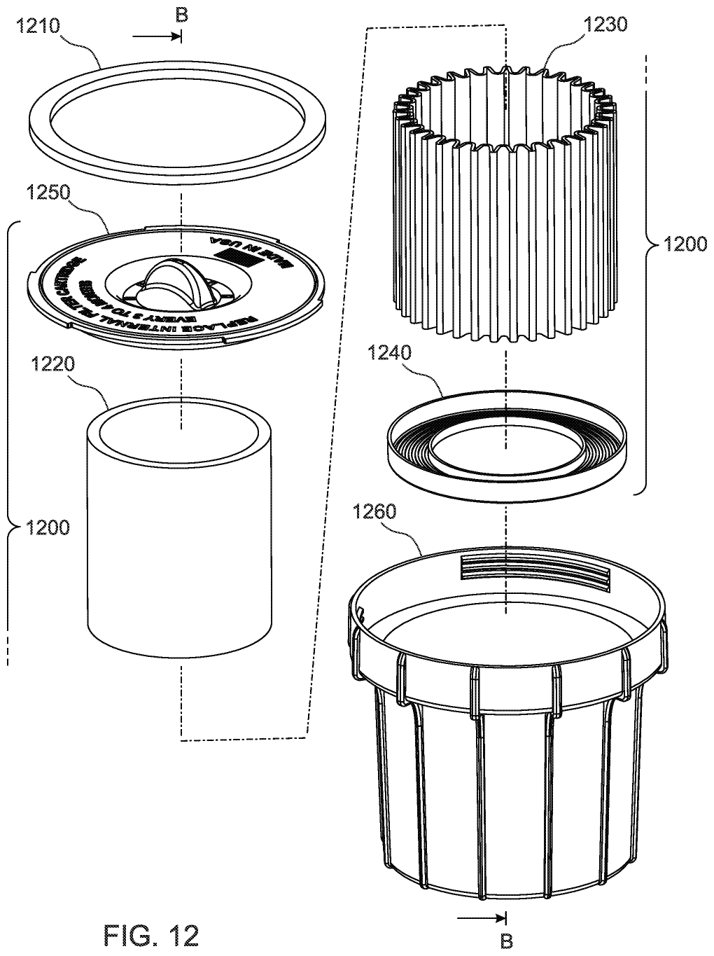

As a replaceable element in a larger system, for example as a bottle filter, water filter 100 may include a straw (not illustrated) and may be inside of a larger bottle or container (see FIG. 11 for example). As a stand-alone filter, water filter 100 may receive a straw (not illustrated) and may be used in emergency situations to drink directly from a stream, river, or other water source. As a replaceable element in a pitcher filter, for example, water filter 100 may connect to a larger water reservoir (see FIG. 12 for example).

Although water filter 100 is cylindrical in FIG. 1, and other aspects of a water filter may be described in this disclosure and illustrated throughout the figures as such, water filter 100 and other aspects of a water filter may have other shapes, for example square, spherical, rectangular, triangular, octagonal, hexagonal, and so on.

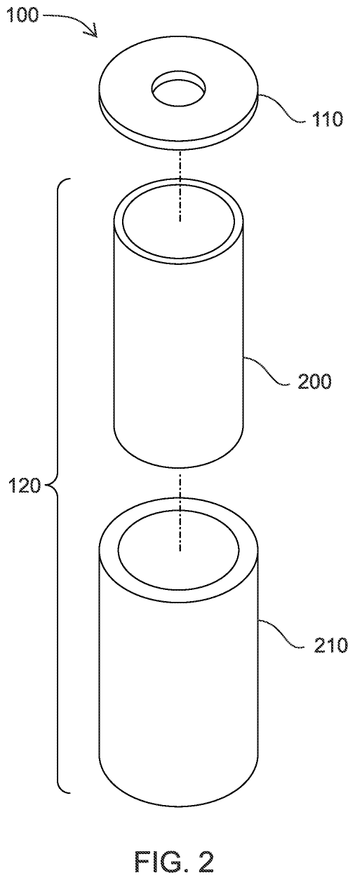

FIG. 2 is a top perspective view illustrating one example of expanded water filter 100. In one aspect of water filter 100, filter element 120 includes electrically charged fiber (ECF) filter 200 and activated carbon fiber (ACF) filter 210. In one aspect, ACF filter 210 has a minimum thickness throughout its side and base (base not visible in FIG. 2), in accordance with filtration requirements. ACF filter 210 may form a “cup” surrounding ECF filter 200, which also may have a cup-shape. In one aspect, ECF filter 200 fits entirely within ACF filter 210, such as two cups, with one nested inside the other. One or both of ACF filter 210 and ECF filter 200 may be bonded or attached to top end-cap 110, as previously described.

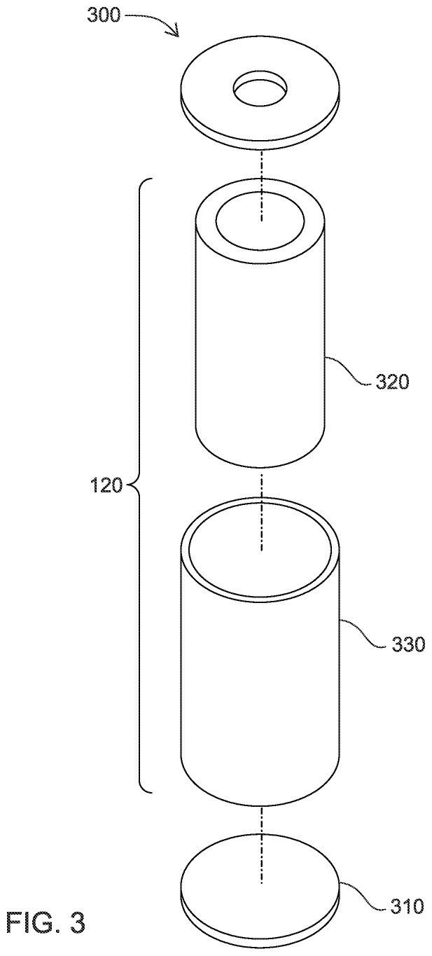

In one aspect of water filter 100, the positions of ACF filter 210 and ECF filter 200 are reversed, such that ECF filter 200 surrounds ACF filter 210 (for example, see FIG. 3). In this aspect, ECF filter 200 forms a “cup” surrounding ACF filter 210. Reversing the position of filters with respect to one another, given a constant filtration direction, may have a similar effect to reversing the filtration direction given a constant filter position. Some advantages of ACF filter 210 being outside of ECF filter 200 include: ACF filter 210 serving as a sediment filter by first encountering water that is to be filtered and trapping particles above a certain size, thus protecting ECF filter 200 and extending its lifespan. Some advantages of ACF filter 210 being inside of ECF filter 200 by first encountering water that is to be filtered include: “polishing” the water and providing better taste for a user. Reversing water flow in water filter 100 may reverse application of the benefits.

FIG. 3 is a top perspective view illustrating one example of expanded water filter 300. In one aspect, water filter 300 may share attributes, structure or characteristics with water filter 100 as previously described. Water filter 300 includes top end-cap 110, bottom end-cap 310 and filter element 120. In one aspect, filter element 120 includes activated carbon fiber (ACF) filter 320 and electrically charged fiber (ECF) filter 330. In one aspect, both ACF filter 320 and ECF filter 330 are open at their top (illustrated) and bottom (not illustrated in FIG. 3). In one aspect the filters are cylindrical, though as previously mentioned other shapes are possible. In one aspect, bottom end-cap 310 seals to both ACF filter 320 and ECF filter 330 in order to ensure liquid passes through both filters. The seal may be, for example, an adhesive, or glue, or a pressure fit.

In one aspect, where water filter 300 may be fully submerged, top end-cap 110 may be sealed to both ACF filter 320 and ECF filter 330. Where water filter 300 may not be fully submerged, top end-cap 110 may be sealed only to ECF filter 330.

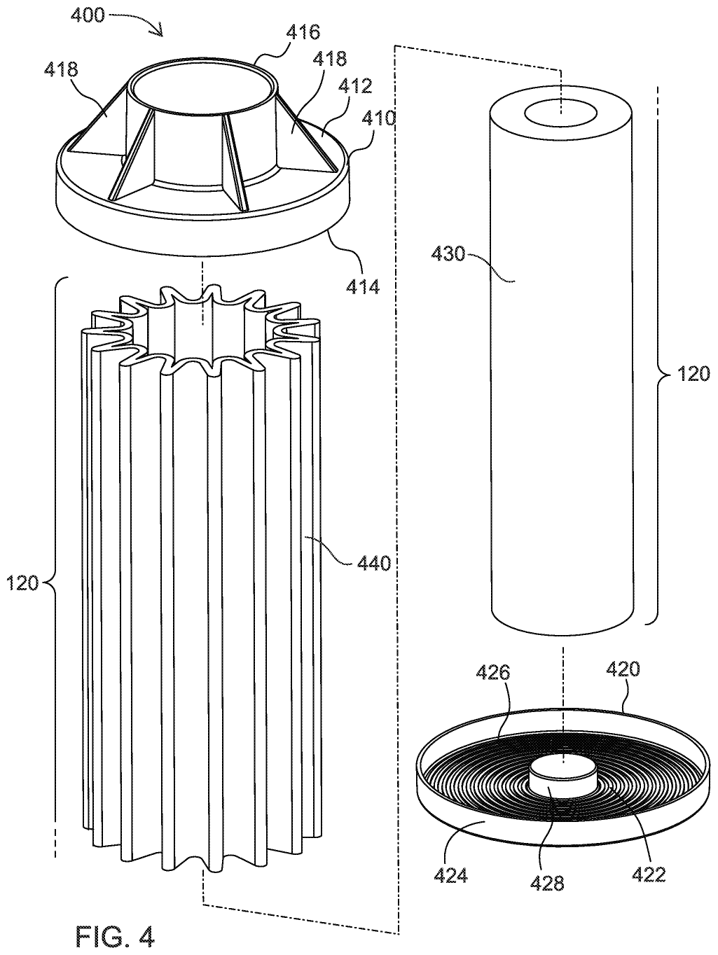

FIG. 4 is a top perspective view illustrating one example of expanded water filter 400. In one aspect, water filter 400 may share attributes, structure or characteristics with water filter 100 and water filter 300 as previously described. Water filter 400 includes top end-cap 410, filter element 120 and bottom end-cap 420. Filter element 120 includes activated carbon fiber (ACF) filter 430 and electrically charged fiber (ECF) filter 440.

In one aspect, top end-cap 410 may be made from a plastic or metal that is extruded, molded or otherwise shaped, cut or formed, for example. Top end-cap 410 includes base 412 and wall 414 that extends away from base 412 and may function to contain and help seal to filter element 120. Top end-cap 410 may have a diameter of about 32 mm, or 31-33 mm, or 30-34 mm, for example. Wall 414 may have a height of about 4 mm, or 3-5 mm, or 2-6 mm, for example. Attached to the underside of base 412 and not visible in FIG. 4 may be a series of concentric ridges extending away from the center of base 412. In one aspect, the concentric ridges on top end-cap 412 are similar to those on bottom end-cap 420 (see below). The concentric ridges may be 1 or more millimeters high, but lower than wall 414. The concentric ridges provide a surface against which filter element 120 may form a seal. At the center of the concentric ridges there may be a hollow ring that is not visible in FIG. 4. In one aspect, the hollow ring on top end-cap 412 is similar to one on bottom end-cap 420 (see below), excepting that the hollow ring is hollow, whereas on bottom end-cap it is not hollow. The hollow ring may be in the center of top end-cap 410 and may extend away from base 412 and in the direction of filter element 120. The hollow ring may help to align filter element 120, seal to filter element 120, and serve as a guide for a straw or other implement that is insertable into water filter 400 and that serves as a conduit for water. The hollow ring may have a height that is greater than, equal to or less than the height of wall 414. The hollow ring may have a height of about 3 mm, or 2-4 mm, or 1-5 mm for example. The hollow ring extends through base 412 and connects to fluid port 416. Fluid port 416 may have a height of about 5 mm, or 4-6 mm, or 3-7 mm. Fluid port 416 may connect to other structures through which water passes during filtering. Supports 418 may extend from base 412 to fluid port 416 and provide rigidity and structural support to top end-cap 410.

In one aspect, bottom end-cap 420 may be made from a plastic or metal that is extruded, molded or otherwise shaped, cut or formed, for example. Bottom end-cap 420 includes base 422 and wall 424 that extends away from base 422 and may function to contain and help seal to filter element 120. Bottom end-cap 420 may have a diameter of about 32 mm, or 31-33 mm, or 30-34 mm, for example. Wall 424 may have a height of about 4 mm, or 3-5 mm, or 2-6 mm, for example. Attached to the top of base 422 and may be concentric ridges 426 extending away from the center of base 422. In one aspect, concentric ridges 426 on bottom end-cap 420 are similar to those on top end-cap 410. Concentric ridges 426 may be 1 or more millimeters high, but lower than wall 424. Concentric ridges 426 provide a surface against which filter element 120 may form a seal. At the center of concentric ridges 426 there may ring 428. In one aspect, the hollow ring on top end-cap 412 is similar to ring 428. Ring 428 may be in the center of bottom end-cap 420 and may extend away from base 422 and in the direction of filter element 120. Ring 428 may help to align filter element 120, seal to filter element 120, and serve as a guide for a straw or other implement that is insertable into water filter 400 and that serves as a conduit for water. Ring 428 may have a height that is greater than, equal to or less than the height of wall 424. Ring 428 may have a height of about 3 mm, or 2-4 mm, or 1-5 mm for example.

Top end-cap 410 and bottom end-cap 420 may form a water-tight seal with filter element 120. The seal may be formed with an adhesive or glue, which may be applied hot or cold. In one aspect ACF filter 430 is inside ECF filter 440, though their respective positions may be reversed with ACF filter 430 outside of ECF filter 440. In one aspect, ACF filter 430 has an outer diameter of about 20 mm, an inner diameter of about 8 mm, and a length of about 58 mm. In one aspect, ACF filter 430 may have an outer diameter of 19-21 mm, or 18-22 mm, or 17-23 mm, for example. In one aspect, ACF filter 430 may have an inner diameter of 7-9 mm, or 6-10 mm, or 5-11 mm, for example. In one aspect, ACF filter 430 may have length of 56-60 mm, or 54-62 mm, or 52-64 mm, for example. In one aspect, ACF filter 430 may have a thickness of 12-19 mm, with the respective inner and outer diameters set to maintain that range. For an individual water filter 400, ACF filter 430 may have a relatively consistent thickness in order to have relatively predictable filtering characteristics. Comparing different water filters, ACF filter 430 may have a different thickness, in one aspect from 6 to 19 mm, or from 0.25 to 0.75 inches. A water filter for a pitcher, for example, may have a different thickness for ACF filter 430 than a water filter for a bottle. In one aspect, for a pitcher, ACF filter 430 may have a thickness from 0.25″ to 0.50″, or 0.50″ to 0.75″, or 0.75″ to 1.0″ for example.

The ACF filter 430 may be relatively homogeneous and may be made from activated carbon fibers prepared through carbonization and activation of fibrous raw material. The activated carbon fiber may be prepared from asphalts, phenolics, synthetic polymers (e.g. polyvinyl alcohol, polyacrylonitrile, polyimide, etc.), lignins and natural plant fibers (e.g. hemp, flax, coconut, etc.). The activated carbon fibers may be prepared by physical activation (disordered carbon atoms in fibrous materials are oxidized to form pores by etching effect with oxygen, carbon dioxide and water vapor as activators), chemical activation (the pore structure is formed via chemical reactions between carbon atoms and phosphoric acid, potassium hydroxide, zinc chloride, or ammonium sulfate) or physical-chemical complex activation processes (the physical and chemical activation methods are combined to achieve a complementarity in the aspect of pore structure regulation and prime cost manipulation. Using biomass as feedstock for activated carbon fiber may be advantageous due to its abundance, non-toxic nature and favorable mechanical properties. Activated carbon fibers, in one aspect those within ACF filter 430, with a high micropore volume and large specific surface area may be prepared using coconut fiber as a precursor through high-temperature carbonization and KOH activation processes. One method of making the activated carbon fiber is to carbonize coconut fibers at 600 C. using a furnace. Along with the coconut fiber is other activated carbon to create an oxygen-free atmosphere. Mixing carbonized coconut palm with a potassium hydroxide ethanoic solution in a 1:2 ratio and heating until the ethanol is dissolved. The dried mixture may be placed in a vacuum tube furnace and heated at 900 C in a nitrogen protected environment for 2.5 hours. The activated carbon fiber is obtained after soaking and rinsing this product with distilled water. This activated carbon fiber may be cut into a desired length and then rolled into a cylindrical shape, in one aspect, until a desired thickness is achieved for ACF filter 130.

Advantages of activated carbon fibers include maintaining high flow rates across ACF filter 430 with low pressure drop, longevity, rapid and high adsorption levels of chemicals, organic and inorganic matter, and heavy metals. Using activated carbon fibers instead of, for example, an activated carbon filter results in a more compact filter with the trade-off of being more expensive and difficult to manufacture. Benefits to using activated carbon fibers may include design flexibility and relatively lower pressure drop.

In one aspect, ECF filter 440 is a layered, metal-infused fiber that may be pleated (or folded) and then shaped into a cylinder. The metal-infused fiber may carry an electrical charge that attracts and bonds with microbiological organisms (for example, harmful bacteria), viruses, cysts in water passing through ECF filter 440, as well as dissolved metals such as copper, tin, iron and aluminum. In one aspect, ECF filter 440 may have length of 56-60 mm, or 54-62 mm, or 52-64 mm, for example. In one aspect, ECF filter 440 and ACF filter 430 have the same length. In one aspect, top end-cap 410 and bottom end-cap 420 each seal to both ACF filter 430 and ECF filter 440.

In one aspect, the pleat height of ECF filter 440 may be 5-6 mm, meaning that the vertical rise from the trough of the pleat to the peak is anywhere from 5 to 6 mm. In another aspect, the pleat height may be 4-8 mm, or 5-8 mm, or 5-9 mm, or less than 10 mm. The greater the pleat height, the easier it is to form or fold the pleats, with pleats 10 mm and up being more easily formed and providing more surface area for a filter, than those under 10 mm. It's advantageous to have greater surface area in a filter, for increased longevity, better flow, and lower pressure drop. A pleated fiber filter with pleats less than 10 mm is more difficult and costly to manufacture, but results in a smaller form factor. A metal-infused fiber filter is also more expensive than other types of filters, for example a paper filter or activated carbon filter.

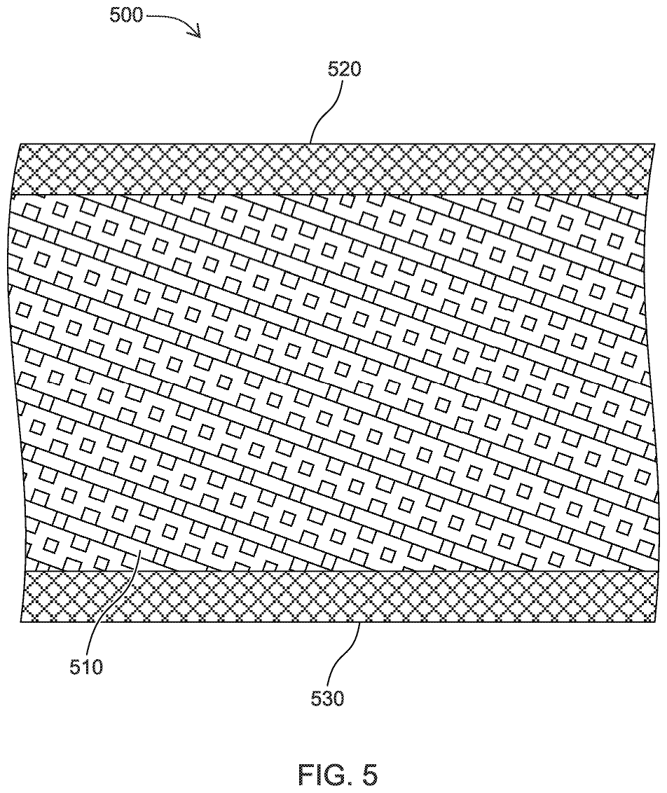

FIG. 5 is a partial cross-sectional view illustrating one aspect of an ECF filter. In one aspect, ECF filter 500 may share attributes, structure or characteristics with ECF filter 200, ECF filter 330 and ECF filter 440 as previously described. ECF filter 500 includes active layer 510 and a single support layer 520. In one aspect, a single support layer is used (in contrast, FIG. 5 illustrates one aspect of ECF filter 500 with multiple support layers). In one aspect, multiple support layers may be used, for example support layer 520 and support layer 530. Support layer 520 adds rigidity, strength, structure and robustness to ECF filter 500, which may be manipulated or formed into shapes beyond a flat layer. Including support layer 530 increases the rigidity, structure, strength and robustness of ECF filter 500. Support layers 520 and 530 may be made from similar, identical or different materials with respect to one another, when both support layers are present.

In one aspect, support layer 520 and if present support layer 530 are made of a synthetic polymer, for example polyester or polypropylene. Support layers 520 and 530 may be held to active layer 510 with an adhesive binder. In one aspect of ECF filter 500, either or both support layers 520 and 530 are made with cellulose (for example, cotton linter pulp GR 505 from Buckeye Cellulose Corp). In one aspect of ECF filter 500, either or both support layers 520 and 530 may be composed of a mesh-like material. In one aspect, support layers 520 and 530 are approximately 0.2 mm thick, with active layer 510 approximately 1.2 mm thick.

One method of manufacturing ECF filter 500 begins with a mulch of cellulose that is poured into a Buchner funnel with a #5 filter, producing support layer 530. While still moist, a mulch of nano alumina/microglass fibers may be poured on top of support layer 530, forming active layer 510. After one hour drying, an additional layer of cellulose mulch may be poured onto active layer 510, forming support layer 520. The laminated structure forming one aspect of ECF filter 500 has greater resistance to tearing in both dry and wet states. The laminated structure eventually forming ECF filter 500 may be flat or rolled in a tube, for example, for transportation.

In order to establish a given level of filtration, a related filter surface area may be used. Surface area is a function of filter height multiplied by width. For example, with reference to FIG. 4, filter height may be roughly understood to be the distance between top end-cap 410 and bottom end-cap 420. In an aspect where ECF filter is flat (not pleated) and stretched over ACF filter 430, the width=2*π*R, where R is the radius of ECF filter (greater than or equal to the radius of ACF filter 430). In an aspect where the filter is not flat, for example pleated ECF filter 440, the surface area added by the pleats would be factored. A given surface area would be expected to filter a given number of gallons based on average expected water quality, for example filtering from 60 to 80 gallons for microbiological contaminants. A given surface area of 0.25 sq ft may be able to filter approximately 100 gallons of water, accounting for other factors, for example flow rate.

One method to establish filter height may be to perforate the laminate structure in order to create the desired height. Depending on the width desired (based on surface area needs) perforation may be followed by cross-cutting. In the aspect of a flat filter (not illustrated), the perforated and cross-cut laminate structure may be wrapped around an ACF filter, and then the ends of the flat filter joined together, creating a side seam. Methods of joining the ends may include applying a hotmelt adhesive, sonic welding, etc. If the ends are not effectively joined, the chance of bypass increases, whereby water passes from one side of the filter to the other without being filtered, through a hole in the filter (for example in the side seam). Bypass decreases filter efficacy and may allow contaminants to enter the drinking water.

In the aspect of a pleated filter, for example ECF filter 440, pleating may be done prior to cross cutting. One method of pleating may include steps as follows. Pre-heat the laminate structure. Pre-heating may be done with ambient temperature from 100° F. to 120° F., 110° F. to 130° F., 120° F. to 140° F., 130° F. to 150° F., 140° F. to 160° F., 15° F. to 170° F., 160° F. to 180° F., for example, with exposure times ranging from 30 seconds to 5 minutes. Next, blade forms with the appropriate depth and angle contact the laminate structure and form the pleats. Pleat formation rate may be from 20-40 pleats per minute, 30-50, 40-60, 50-70, 60-80, and up to 110 pleats per minute, for example. After the pleats are formed, post-heating may occur at a temperature from 95° F. to 105° F., 100° F. to 110° F., 105° F. to 115° F., 110° F. to 120, 115° F. to 125° F., for example. Post-heating may occur from 10 seconds to 2 minutes and may assist in maintaining the pleat shape prior to cross-cutting. After post-heating the pleated filter may be cross cut for a desired surface area. One example of ECF filter 500 is DISRUPTOR owned by AHLSTROM.

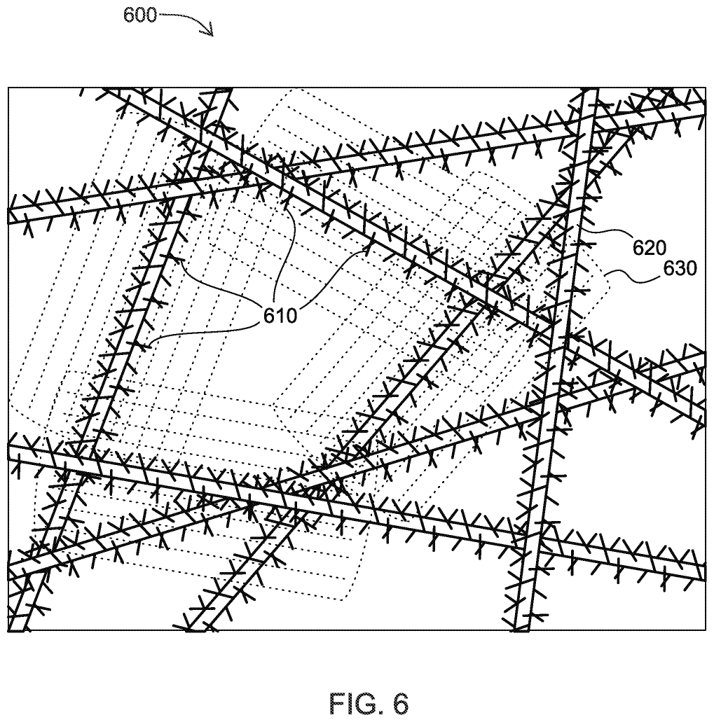

FIG. 6 is a magnified view illustrating one example of a magnified active layer 600 in an ECF filter. In one aspect, active layer 600 may share attributes, structure or characteristics with active layer 510 as previously described. In one aspect, active layer 600 is an alumina fiber layer carrying an electrical charge. The electrical charge may be positive or negative. In one aspect the electrical charge is positive because a greater proportion of solutes (that a user would be interested in removing by filtration) carry a net negative charge. Entities such as viruses, bacteria, pyrogens, prions, macromolecules, nucleic acids, colloids, proteins and enzymes have electronegative surface charge and are attracted to a positive charge. One of the mechanisms for contaminant removal (filtering) is through charge interaction between active layer 600 and solutes. As a fiber-based matrix, active layer 600 filters bacterial and sub-micron particulates such as viruses or colloids at flow rates many times greater than ultra porous membranes capable of size-equivalent removal. In one aspect,

Active layer 600 may include alumina nanofibers 610 attached to a nonwoven matrix of micro-glass fibers 620. In one aspect, the nonwoven matrix may be a borosilicate fiber-glass filter media. In one aspect, micro-glass fibers 620 may include cellulose. In one aspect, alumina nanofibers 610 may have a diameter of about 2 nm and a length of about 250 nm. Charge field 630 extends about 1 μm from each nanofiber 610 and in one aspect is positive. Charge field 630 extends through water to adsorb contaminants attracted to a positive charge. Charge field 630 extends throughout active layer 600. In one aspect, active layer 600 has a depth of approximately 0.8 mm, creating an average pore size of 0.7 μm. Active layer 600 may act as a depth filter media with a pressure drop of approximately 0.2 bar. FIG. 6 is exemplary and does not show a totality of nanofibers or charge fields, nor is FIG. 6 drawn to scale. Rather, FIG. 6 is meant to convey an understanding of some of the relationships and materials described herein.

Alumina nanofibers 610 may be particles with a longitudinal/cross section ratio in excess of about 5, where the smallest dimension is less than about 100 nanometers. The cross section of the “fiber” may be circular (cylindrical fiber) or rectangular in shape (platelet). The fibers are comprised of alumina, with various contents of combined water to result in compositions of pure Al(OH)3 or AlOOH or mixtures of the two, with possible impurities of gamma and alpha alumina.

Nano size aluminum hydroxide fibers may be produced by a number of different methods. U.S. Pat. Nos. 2,915,475 and 3,031,417 describe the preparation of boehmite fibers from very low cost chemicals (alum, sodium bicarbonate and acetic acid) by a hydrothermal reaction. Gitzen describes several methods of producing fibers, including reacting aluminum amalgams with water and by reacting aluminum with acetic acid. After aging of the sol produced by this latter reaction, fibrous hydrated alumina crystals 20 nm-50 nm in diameter are formed. Alumina fibers have also been produced by the controlled oxidation of molten aluminum by a mixture of oxygen and a gas diluent. However, small globules of aluminum usually contaminate the fibers. U.S. Pat. No. 3,947,562 describes its preparation via the oxidation of gaseous aluminum trichloride with carbon dioxide at 1275° C.-1700° C. in the presence of sufficient hydrogen to combine with the chlorine to form HCl. These fibers are very coarse and have particles as well as other forms present. U.S. Pat. No. 4,331,631 describes the formation of alumina fibers by oxidizing stainless steel containing aluminum. The alumina fiber coating was adherent and used for fabricating automotive catalytic converters after impregnating the alumina-base coating with platinum. Khalil produced long and short boehmite fibers by hydrolysis of aluminum alkoxide.

In one aspect, aluminum oxide fibers may be produced by the reaction of micron size and nano size aluminum powder with water. The electro explosion of metal wire may produce the preferred aluminum metal powder. Aluminum wire with a diameter of about 0.3 mm is fed into a reactor containing about 3 atmospheres of argon absolute. A section about 100 mm long is electrically exploded by applying to the wire about 500 Joules (about 25 KV @ peak voltage of 20 KA where the capacitance of the capacitor bank is 2.4 μF). During the pulse that lasts about 1 microsecond, temperatures exceeding 10,000 Kelvin are produced, as well as x-ray and ultraviolet energy. Metal clusters are propelled through the argon resulting in high quench rates and a complex microstructure in the aluminum once frozen. Yavorovski describes the process and equipment. The aluminum may be exposed to dry air to passivate (oxidize) the surface so that it can be handled in ambient air without ignition. The resulting nano aluminum spheres are fully dense spherical particles with an average size of about 110 nanometers and are somewhat agglomerated. The BET surface area is approximately 20 m2/g.

The resulting nano metal aluminum is reacted with water at 75° C. to produce alumina sol that is filtered and subsequently heated. In the first step, the powder is dried at 100° C.-110° C. The resulting powders are heat-treated at a temperature range from about 200° C. to 450° C. creating a mixture of aluminum hydroxide, Al(OH)3 and boehmite (AlOOH). The higher the temperature, the greater the boehmite yield and the lower the tri-hydroxide yield.

An alternate method involves electro exploding aluminum wire in a nitrogen environment, at 3 atmospheres absolute pressure. Nitrogen is lower cost than argon and eliminates the passivation step since the nitride coated nano aluminum is not pyrophoric. In this case, the aluminum metal particle is coated with a layer of aluminum nitride (AlN). When hydrolyzed, boehmite fibers are produced. Ammonia and hydrogen are also produced as the principal gaseous by-products.

In order to reduce by-pass and channeling of fluids through packed beds of fibers, for example micro-glass fibers 620, fibers may be integrated into a fibrous composite. Non-woven webs of fibers, 25 mm in diameter (surface area ¹⁸5 cm2) may be prepared by mulching a mixture of nano alumina with glass microfibers (Type B-06-F from Lauscha Fiber International, dimensions 0.6μ diameter, 2-3 mm long) in water. About 1.5-2 grams of microglass may be mixed into 400 ml of distilled water and various quantities of nano alumina powder may be added to produce different ratios of microglass/nano alumina filters. The mixture was blended in a conventional blender at the highest setting. After preparation, the nano alumina/microglass composite may be filtered by suction through a 5μ pore size filter to produce a thin fibrous mat of nano alumina and glass microfibers. The mat may be separated from the coarse filter and air-dried at room temperature. One advantage of nano alumina fibers as compared to spherical particles with equivalent surface area is that the large aspect ratios (tens to hundreds) allows them to be readily integrated into fibrous structures. The fibrous structure produces filters that are highly porous (approximately 70-80% void volume). Aluminum nanofibers may be sieved through a 400-mesh screen to yield fibers small enough to be uniformly distributed through the filter media.

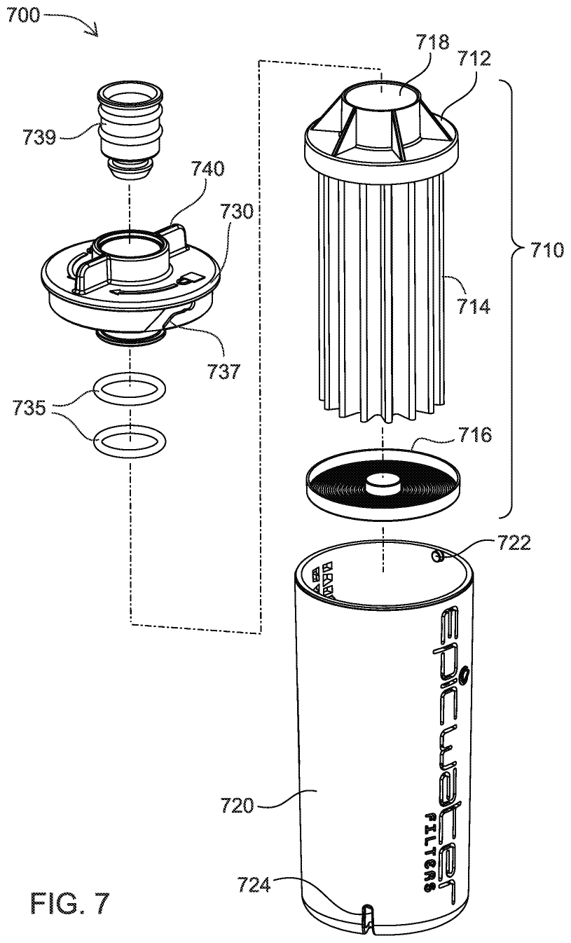

FIG. 7 is a top perspective view illustrating one example of filter unit 700. Included are water filter 710, housing 720 and lid 730. In one aspect, water filter 710 may share attributes, structure or characteristics with water filter 400, water filter 100 and water filter 300 as previously described. Water filter 710 includes top end-cap 712, filter element 714, and bottom end-cap 716. Filter element 714 may include activated carbon fiber (ACF) filter (not illustrated in FIG. 7) and electrically charged fiber (ECF) filter.

One or more gaskets 735, which in one aspect may be O-rings, may securely fit on a protrusion of the lower part (not illustrated in FIG. 7) of lid 730. The protrusion of lid 730 may be sized to engagedly fit within fluid port 718 of top end-cap 712. One or more of gaskets 735 may provide a seal between top end-cap 712 and lid 730. In an aspect with a single gasket, the single gasket may fit within fluid port 718. In an aspect with multiple gaskets, one gasket may fit within fluid port 718 while another gasket contacts the top edge of fluid port 718. In an aspect with multiple gaskets, multiple gaskets may fit within fluid port 718.

Water filter 710 may engagedly fit to lid 730 and form a unit that may be inserted into housing 720. Lid 730 may secure to housing 720 in different ways, for example threaded, pressure, latches, bands, etc. In FIG. 7, lid 730 may include guide 737 that engages with post 722 on housing 720. Although a single guide 737 and post 722 are illustrated, multiple guides and posts may be included. Lid 730 may include nozzle 739, conformably fitting into the top of lid 730. Nozzle 739 may provide a water-tight seal to lid 730 for a tube, for example a straw in a water bottle, or a water reservoir from a pitcher (neither illustrated in FIG. 7).

In one aspect, a straw (not illustrated in FIG. 7) may be inserted into filter unit 700 through lid 730, with a water-tight seal formed between the straw, nozzle 739 and lid 730. Additionally, a water-tight seal may exist between lid 730 and water filter 710. A straw may be partially or nearly fully inserted (full insertion risks blocking the straw entrance against bottom end-cap 716 and thus have reduced or no water intake) into filter unit 700. Inlet 724 may provide water with passage from outside filter unit 700 and with water pressure or suction applied to a straw, further to the interior of housing 720. Although a single inlet 724 is illustrated, multiple inlets may be included, with different shapes or locations. In one aspect, water filter 710 is sized such that, when correctly engaged with lid 730, bottom end-cap 716 is within 2-3 mm of contact with housing 720. In one aspect, water filter 710 is sized such that, when correctly engaged with lid 730, bottom end-cap 716 is in contact with housing 720. In one aspect, water filter 710 is sized such that, when correctly engaged with lid 730, bottom end-cap 716 is greater than 3 mm from contact with housing 720. With water filter 710 mounted to lid 730 and inside housing 720, water may be drawn into housing 720 and through the porous parts of water filter 710 by pressure, for example negative vacuum pressure applied to a straw, or gravity pressure acting on a column of water.

After some period of use, replacement of water filter 710 is necessary. Water filter 710 may be user-replaceable, wherein a user removes filter unit 700 from, for example, a bottle or pitcher, by disengaging lid 730 from housing 720. In one aspect, a user may press tabs 740 on either side of lid 730, causing a counterclockwise rotation of lid 730. The engagement of post 722 within guide 737 allows rotation of lid 730 followed by disengagement of lid 730 from housing 720, allowing and assisting in removal of lids 730 from housing 720. After removing lid 730 and water filter 710 from housing 720, the user may replace the clogged filter element with a new filter element. After replacement with a new filter element, lid 730 with new water filter 710 are re-inserted and secured to housing 720, which may then be replaced into, for example, a bottle or pitcher. Replacement of water filter 710 may occur based on criteria such as gallons filtered, passage of a period of time, or increased difficulty in drawing water through the filter (or a decreased rate of filtering, for example filtering 1 gallon per hour as compared to 2 gallons per hour, in a gravity fed system).

In one aspect, housing 720 and water filter 710 are cylindrical. In one aspect, housing 720 and water filter 710 are non-cylindrical, for example square, rectangular, triangular, etc. Lid 730 may conform to an appropriate shape in fitting to housing 720.

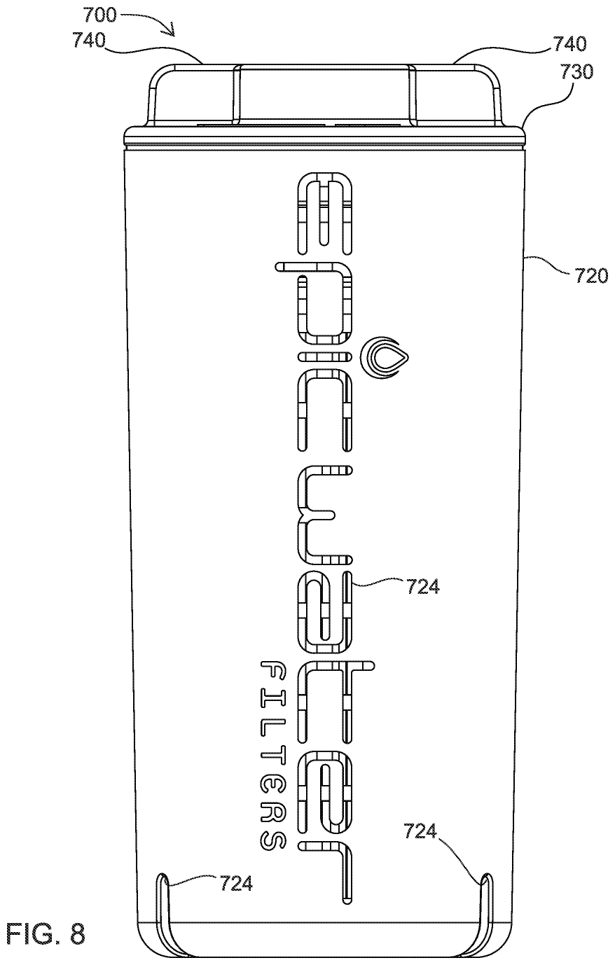

FIG. 8 is a plan view illustrating one example of filter unit 700 from FIG. 7. In one aspect, housing 720 includes inlets 724, which may optionally include inlets shaped according to a logo, company name, design, or other words. Lid 730 is illustrated in a closed position with respect to housing 720, with tabs 740 on both sides of the top of lid 730.

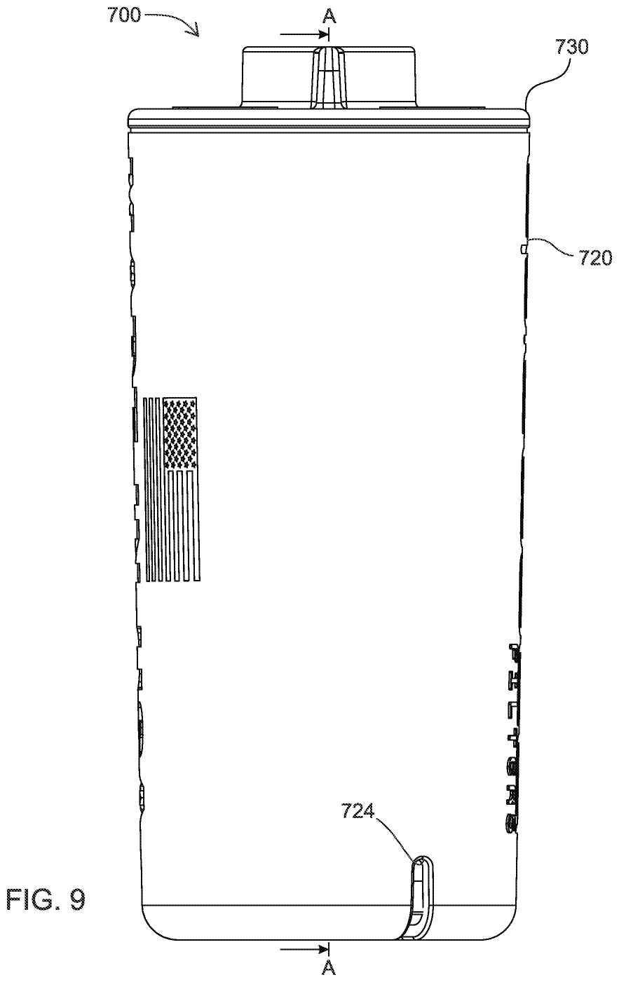

FIG. 9 is a plan view illustrating one example of filter unit 700 from FIG. 8, rotated 90 degrees with respect to the plan view in FIG. 8. In one aspect, housing 720 includes inlet 724. Lid 730 is illustrated in a closed position with respect to housing 720, with tab 740 visible on top of lid 730.

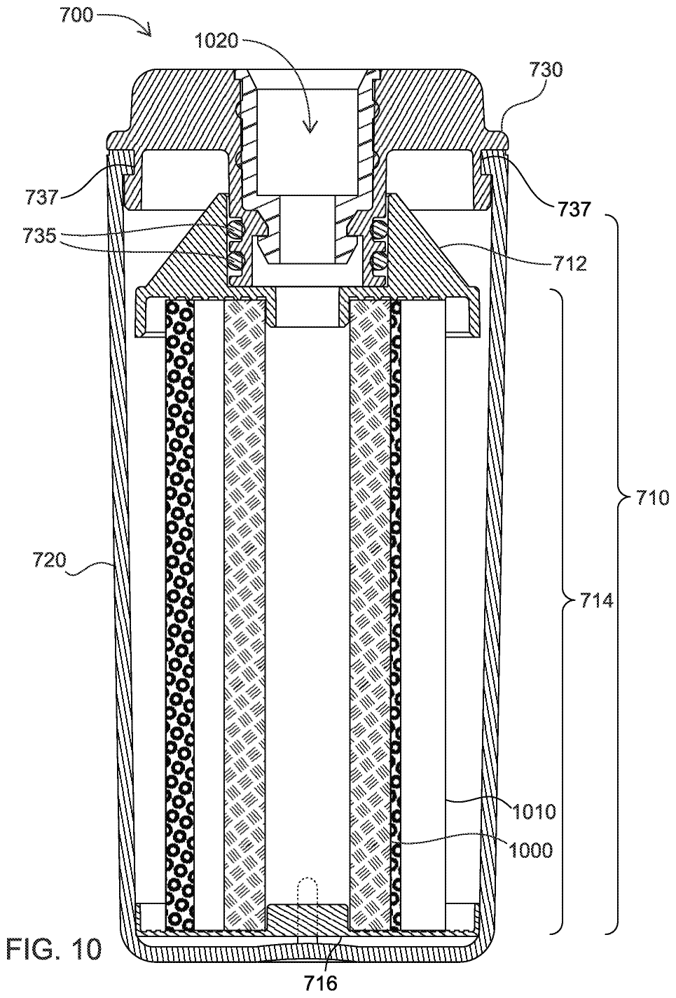

FIG. 10 is a cross-sectional view through line A-A of FIG. 9 illustrating one example of filter unit 700 from FIG. 9. Water filter 710 includes filter element 714 with top end-cap 712 and bottom end-cap 716. Filter element 714 may include activated carbon fiber (ACF) filter 1000 surrounded by electrically charged fiber (ECF) filter 1010. Water filter 710 connects to lid 730 and gaskets 735. Housing 720 connects to lid 730 through guides 737 and one or more of post 722 (not illustrated in FIG. 10).

In one aspect of operation, a straw or other water-transport tube (see FIG. 11) may be inserted into central area 1020 and down into filter unit 700. With filter unit 700 submerged in water, vacuum pressure through a straw, for example, may draw water surrounding filter unit 700 through inlets 724 (not illustrated in FIG. 10) in housing 720 and through filter element 714, and into the central area 1020, thus filtering the water by passage through filter element 714. In one aspect and in reverse operation from what was just described, a water transport tube supplies water into the central area 1020 and pressure moves the water from inside filter element 714, through filter element 714 and eventually outside filter unit 700, also filtering the water.

FIG. 11 is a perspective partial cutaway view of one example of a bottle containing a filter. In one aspect, filter unit 700 from FIG. 9 includes straw 1100 removably inserted into filter unit 700. Straw 1100 may be held in place by nozzle 739 (not illustrated in FIG. 11, see FIG. 7), which creates a seal between filter unit 700 and straw 1100. Straw 1100 exits bottle 1110 through top 1120, which helps to secure straw 1100 within bottle 1110. A user may fill bottle 1110 with water of questionable quality. By sucking on available end 1115 of straw 1100, a user may draw water within water bottle 1110 into filter unit 700, thereby causing the water to be filtered by filter unit 700. Once the water passes into filter unit 700 it may be drawn up straw 1100 and consumed by the user.

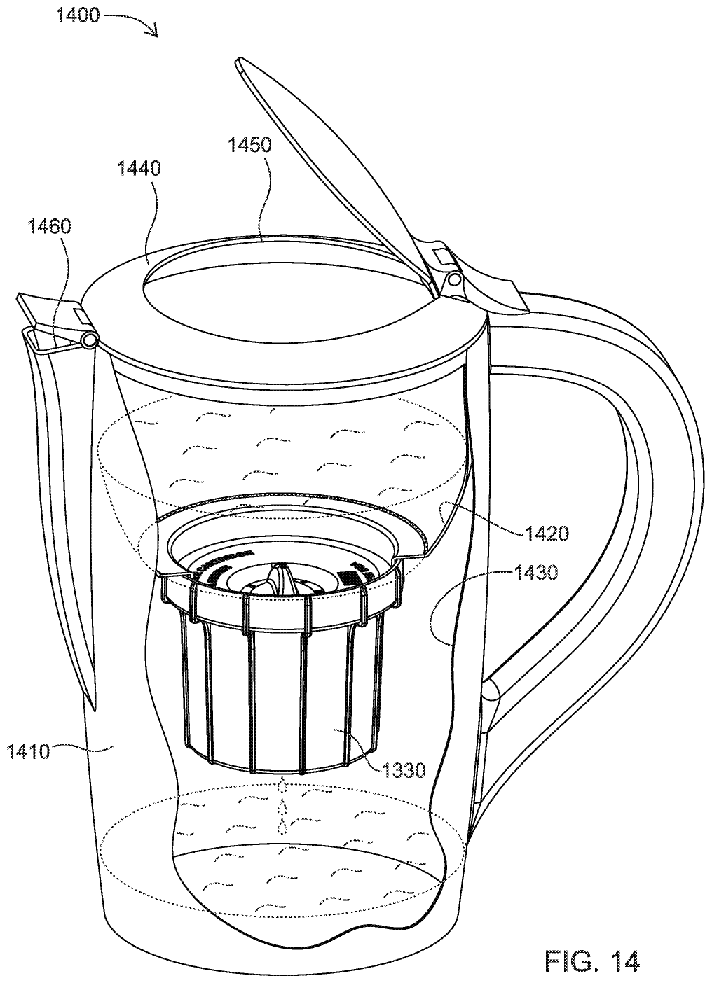

FIG. 12 is a top perspective view illustrating one example of expanded water filter 1200. In one aspect, water filter 1200 may share attributes, structure or characteristics with water filter 710, water filter 400, water filter 300 and water filter 100 as previously described. In one aspect, water filter 1200 may include activated carbon fiber (ACF) filter 1220 inside electrically charged fiber (ECF) filter. Sealed to filters 1220 and 1230 on one end may be bottom end-cap 1240 and on the other end, top end-cap 1250. Housing 1260 may surround filters 1220 and 1230, and may thread to a pitcher reservoir (see FIG. 14), with top end-cap 1250 held in place by pressure between the reservoir and housing 1260. Gasket 1210 mayhelp to seal housing 1260 and top end-cap 1250 against the reservoir. In one aspect, granular media (for example granulated carbon or carbon block media—not illustrated) may be located in the inner cavity of ACF filter 1220. Water filter 1200 may be a user-replaceable or user-serviceable component in a pitcher filter, for example.

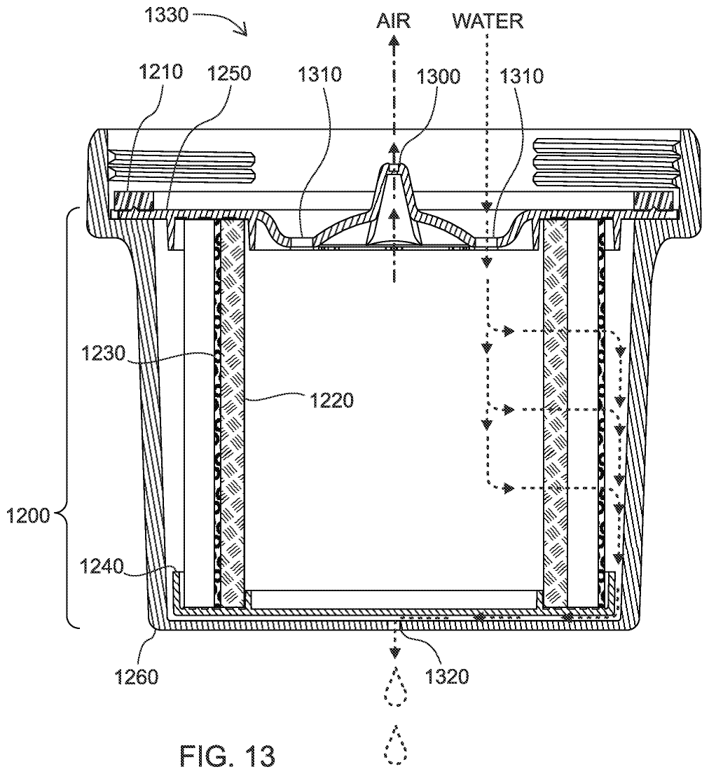

FIG. 13 is a cross-sectional view through line B-B of FIG. 12 illustrating one example of water filter 1200 and housing 1260. Top end-cap 1250 may include air vent 1300 and inlets 1310. Housing 1260 may include outlet 1320.

In one aspect, water flow direction is described with respect to a water pitcher filter as illustrated in FIG. 13. Unfiltered water (not illustrated in FIG. 13) may be stored above housing 1260 and in contact with top end-cap 1250. In one aspect, housing 1260 may attach to a reservoir (not illustrated in FIG. 13, see FIG. 14) with storage areas for filtered and unfiltered water. Gasket 1210 may help seal pitcher filter unit 1330 to the reservoir and to the storage area for unfiltered water.

Water may enter pitcher filter unit 1330 through inlets 1310. Air may exit pitcher filter unit 1330 through one or more of vent 1300. Once water is inside of pitcher filter unit 1330, and inside a hollow interior of ACF filter 1220, gravity may push water through ACF filter 1220 and through ECF filter 1230. Optionally there may be granular media (not shown) within ACF filter 1220. Under continued pressure by gravity, water that is now filtered and within housing 1260 but outside of ECF 1230 will flow to the bottom of housing 1260 and exit through outlet 1320. Filtered water that exits outlet 1320 may flow into a storage area for filtered water that may be attached to or part of the reservoir. Although a particular water flow path is illustrated in FIG. 13, water may completely fill pitcher filter unit 1330 and follow multiple flow paths not illustrated in FIG. 13 but consistent with the arrangement of filters 1220 and 1230 and housing 1260.

Pitcher filter unit 1330 may attach to the reservoir through a threaded coupling, for example. Pitcher filter unit 1330 may be removed from the reservoir with water filter 1200 being a user replaceable or user serviceable component

FIG. 14 is a perspective partial cutaway view of one aspect of a pitcher containing a water filter. Pitcher filter 1400 may include pitcher filter unit 1330 attached to reservoir 1410. Reservoir 1410 may include unfiltered water storage area 1420 and filtered water storage area 1430. In one aspect, reservoir 1410 may have lid 1440 sealing to unfiltered water storage area 1420 with opening 1450 into which unfiltered water may be added. Once added, water may be drawn by gravity from unfiltered water storage area 1420 into pitcher filter unit 1330. Upon exiting pitcher filter unit 1330, filtered water may be container in filtered water storage area 1430. In one aspect, filtered water may be poured out of pitcher filter 1400 through spout 1460. Lid 1440 may seal to reservoir 1410 such that unfiltered water and filtered water do not mix when pitcher filter 1400 is tilted in order to pour filtered water.

FIGS. 12-14 illustrate one aspect of a pitcher filter and one configuration of filters, and one water flow path. Not discussed for FIGS. 12-14, but considered to be alternative aspects of a water pitcher filter, are all the variations in filter arrangements, materials, and alternative flow paths discussed throughout this specification.

Throughout this disclosure reference is made to water filtration, water filters, water, and so on. One of ordinary skill in the art understands that this includes consumable liquids in general, and is not limited to water.

The aspects and features mentioned and described together with one or more of the previously detailed examples and figures, may as well be combined with one or more of the other examples in order to replace a like feature of the other example or in order to additionally introduce the feature to the other example.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

It is to be understood that the disclosure of multiple acts, processes, operations, steps, or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts,-functions, -processes,-operations or-steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to also include features of a claim to any other independent claim even if this claim is not directly made dependent on the independent claim.

What is claimed is:

1. A water filter comprising:
an activated carbon fiber (ACF) filter having an inner wall and an outer wall, with a thickness defined by the distance between the inner and outer walls, the ACF filter further including a hollow interior defined by the inner wall;
an electrically charged fiber (ECF) filter comprising a support layer coupled to an active layer, the active layer comprising a plurality of electrically charged fibers, the ECF filter coupled to the ACF filter; and
a top end-cap coupled to at least one of the ACF filter and the ECF filter, the top end-cap configured to provide access from outside of the water filter to the hollow interior.

2. The water filter of claim 1, the ECF filter surrounding the ACF filter.

3. The water filter of claim 2, the ECF filter and the ACF filter each having a cylindrical shape, further comprising a bottom end-cap coupled to both the ACF filter and the ECF filter.

4. The water filter of claim 3, the ECF filter having a plurality of pleats, the active layer further comprising an alumina fiber layer with a positive electrical charge.

5. The water filter of claim 4, the alumina fiber layer further comprising aluminum oxide fibers having a diameter from 1 to 10 nanometers with a longitudinal/cross section ratio in excess of 5.

6. The water filter of claim 4, the alumina fiber layer further comprising a combination of aluminum hydroxide (Al(OH)₃) and boehmite (AlOOH).

7. The water filter of claim 4, the active layer coupled to the support layer.

8. The water filter of claim 7, the support layer further comprising a synthetic polymer.

9. The water filter of claim 7, the active layer further comprising a borosilicate fiberglass filter media.

10. The water filter of claim 7, the ECF filter further comprising a blend of alumina fibers and microglass having from 70% to 80% void volume.

11. The water filter of claim 7, the ECF filter further comprising a non-woven matrix of microglass fibers, cellulose and alumina fibers.

12. The water filter of claim 7, the support layer further comprising a plurality of support layers, the active layer between at least two of the plurality of support layers.

13. The water filter of claim 12, the pleats having a height of less than 10 millimeters.

14. The water filter of claim 7, the bottom end-cap further comprising:
a base;
a wall extending away from the base and encircling the base;
a ring extending away from the base and centrally positioned; and
a plurality of concentric ridges extending away from the base and located between the wall and the ring, the concentric ridges having a height lower than a height of either the wall or the ring.

15. The water filter of claim 13, the top end-cap further comprising:
a base;
a wall extending away from and encircling the base of the top end-cap;
a hollow ring extending away from the base of the top end-cap and centrally positioned, the hollow ring of the top end-cap having a space extending from one side of the circular base of the top end-cap and through the center to the opposite side of the circular based of the top end-cap;
a plurality of concentric ridges extending away from the base of the top end-cap and located between the wall of the top end-cap and the ring of the top end-cap, the concentric ridges of the top end-cap having a height lower than a height of either the wall of the top end-cap or the ring of the top end-cap; and
a fluid port attached to the base of the top end-cap on a side opposite the concentric ridges of the top end-cap, the fluid port extending away from the base of the top end-cap and providing fluid access between the hollow interior and outside the water filter.

16. The water filter of claim 14, the top end-cap and bottom end-cap each sealed to the ECF filter with an adhesive.

17. The water filter of claim 14, the ACF filter thickness from 0.25″ to 0.75″.

18. The water filter of claim 14 further comprising:
a housing having an inlet; and
a lid removably coupled to the housing and removably coupled to the top end-cap, the combination of the housing and lid surrounding the ACF filter, the ECF filter, the top end-cap and the bottom end-cap, the inlet providing passage for liquid from outside the housing and through the ECF filter and ACF filter into the hollow interior.

19. The water filter of claim 14 further comprising:
a reservoir with separate storage areas for filtered and unfiltered water;
a housing removably coupled to the top end-cap, the housing further coupled to the reservoir, the housing configured to hold liquid and provide passage of liquid from the storage area for unfiltered water, into the hollow interior, from the hollow interior through the ACF filter and ECF filter, out of the housing and into the storage area for filtered water; and
a gasket between the housing and the reservoir.

20. A filter comprising:
a cylindrical case having a bottom, a wall coupled to the bottom and extending away from the bottom, and at least one knob extending from the wall and on the inside of the container, and an inlet;
a lid fitting partially into the case, having a lip contacting an edge of the wall,
the lid having at least one channel along the portion of lid fitting into the case, the channel sized larger than the knob and enabling the lid to rotatably engage with the case; and
a replaceable element including an active carbon fiber layer coupled to an electropositive alumina fiber layer, the replaceable element removably coupled to the lid.

21. A pitcher filter comprising:
a reservoir with separate storage areas for filtered and unfiltered water; and
a replaceable element including an active carbon fiber layer coupled to an electropositive alumina fiber layer, the replaceable element removably coupled to the reservoir and configured to guide water from the storage area for unfiltered water, through the active carbon fiber layer and the electropositive alumina fiber layer, and into the storage area for filtered water, with the assistance of gravity.
